(19) United States
(12) Patent Application Publication
(10) Pub. No.: US 2011/0268913 A1
(43) Pub. Date: Nov. 3, 2011

(54) Composite Board

(76) Inventor: Wei Fern Choo, Singapore (SG)

(21) Appl. No.: 12/678,878

(22) PCT Filed: Nov. 27, 2008
(86) PCT No.: PCT/SG2008/000449

§ 371 Date: Mar. 18, 2010

(51) Int. Cl. B32B 3/06; B32B 3/30; B32B 5/00; B32B 3/00; B32B 3/26; B32B 7/02

(52) U.S. Cl. 428/100; 428/319.1; 428/215; 428/220; 428/141; 428/172

(57) ABSTRACT

A composite board (10) comprising a first (12) and fifth layer (14) of thermoplastic material, a second (16) and fourth layer (18) of metal and a third layer (20) made from a combination of thermoplastic material and a reinforcing filling agent, the third layer including at least one hollow void (24). The second (16) and fourth layers (18) are fixed to the third layer (20) through thermal bonding and the first layer (12) and fifth layer (14) are extruded over the second layer (16) and fourth layer (18) respectively.

### FIELD OF THE INVENTION

The invention relates to a composite board.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Outdoor constructions require material that are suited to withstand the effects of the weather and other environmental factors. Such material must also be durable in situations where the outdoor construction is anticipated to be a permanent construction.

Some of the current materials used in outdoor construction as not environmentally friendly. Alternative materials break easily.

It is therefore an object of the present invention to produce a composite board which is better able to withstand the effects of use in an outdoor environment and is environmentally friendly.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention, there is a composite board comprising:
a first and fifth layer of thermoplastic material;
a second and fourth layer of metal; and
a third layer made from a combination of thermoplastic material and a reinforcing filling agent, the third layer including at least one hollow void,
   where the second and fourth layers are fixed to the third layer through thermal bonding and the first layer and fifth layer are extruded over the second layer and fourth layer respectively.

The thermoplastic material is at least one of the following: polyethylene; polypropylene; polyvinyl chlorate; polystyrene; acrylonitrile butadiene styrene.

The metal is at least one of the following: aluminium; stainless steel; copper.

The reinforcing filling agent is at least one of the following: wood filler, talc filler; fibreglass.

The thickness of the various layers can vary. For instance, the first and fifth layers can have a thickness of 0.5 mm to 5.0 mm. The second and fourth layers can have a thickness of 0.1 mm to 1.0 mm. The thickness of the third layer can vary between 5 mm and 50 mm. The total thickness of the composite board, however, should be between 10 mm and 60 mm.

Preferably, the thermoplastic material makes up between 20% and 70% of the total material of the third layer.

At least one side of the first and fifth layers may be textured. Further, ridges may be provided to prevent slippage.

Connecting means may be included to facilitate the connection of adjacent composite boards. These connecting means may take the form of one or more of the following configurations: hook and recess; screw and threaded recess.

Alignment aids may be included for facilitating alignment of adjacent composite boards. These alignment aids may take the form of dowels.

In accordance with a second aspect of the invention there is a composite board comprising:
a first and seventh layer of a first thermoplastic material;
a second and sixth layer of metal;
a third and fifth layer of a second thermoplastic material; and
a fourth layer made from a combination of thermoplastic material and a reinforcing filling agent, the fourth layer including at least one hollow void,
   where the second and sixth layers are fixed to the third and fifth layers, respectively, through thermal bonding, which are in turn thermally bonded to the fourth layer, and the first layer and seventh layer are extruded over the second layer and sixth layer respectively.

The first thermoplastic material may be identical to the second thermoplastic material.

### BRIEF DESCRIPTION OF THE DRAWINGS

The invention will now be described, by way of example only, with reference to the accompanying drawings, in which:

FIG. 1 is an exploded view of a composite board according to a first embodiment of the present invention.

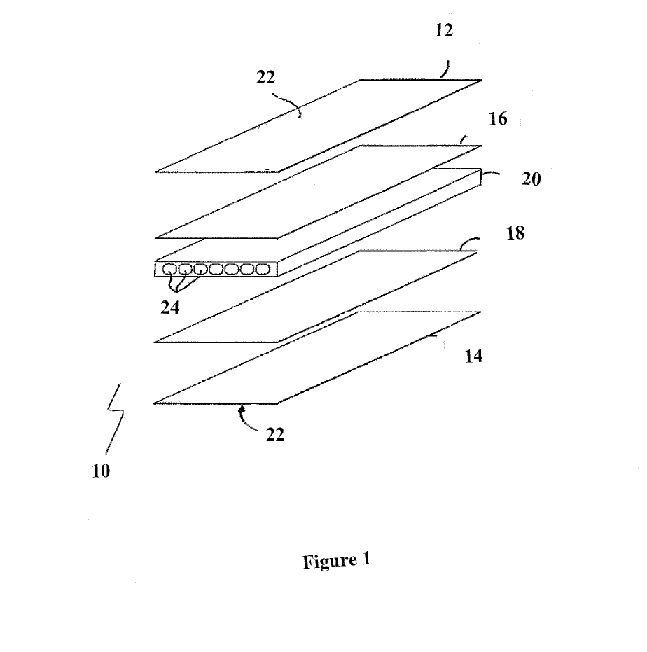

FIG. 2 is an isometric view of a composite board according to the embodiment as shown in FIG. 1.

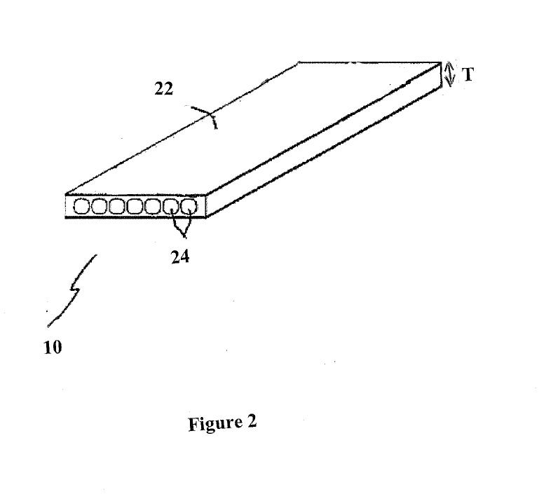

FIG. 3 is an isometric view of a first modified composite board according to the embodiment as shown in FIG. 1.

FIG. 4 is a plan view of a composite board according to a second embodiment of the present invention.

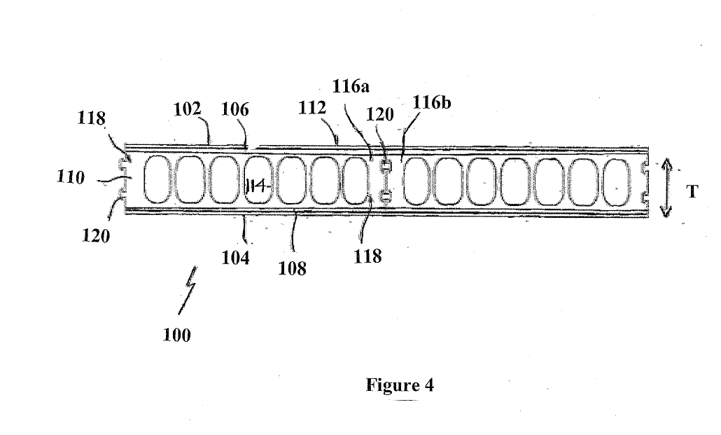

FIG. 5 is an exploded view of a composite board according to a third embodiment of the present invention.

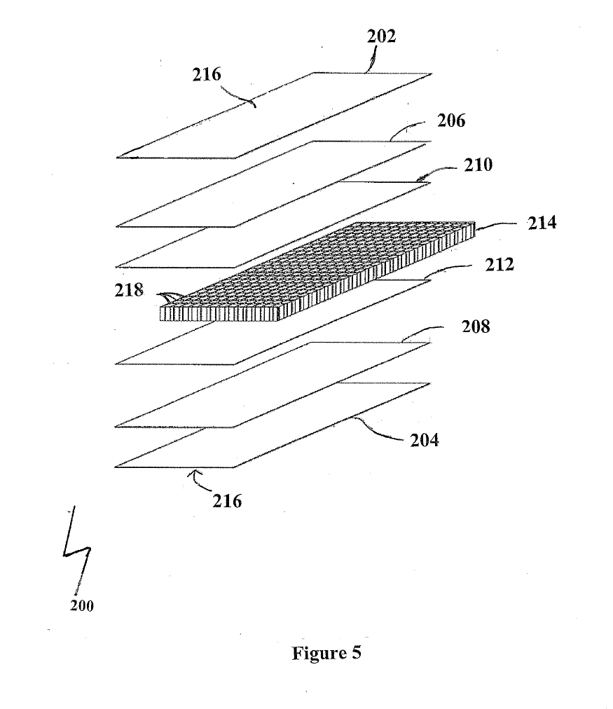

### PREFERRED EMBODIMENTS OF THE INVENTION

In accordance with a first embodiment of the invention there is a composite board 10 of 10 mm thickness (T). The composite board 10 comprises five layers of various material compositions. The first layer 12 and the fifth layer 14 form a plastic cover made from a thermoplastic material having a thickness of 0.5 mm. The second layer 16 and fourth layer 18 are made of metal, in this case aluminium sheeting of 0.1 mm thickness. The third, middle, layer 20 is made from a combination of a thermoplastic material and a filler material. In this case, the thermoplastic material is polyethylene and the filler material is talc filler. The third layer 20 has a thickness of 8.8 mm.

The first layer 12 and the fifth layer 14 each have at least one textured surface 22. The textured surface 22 is positioned such that it acts as an external face of the composite board 10.

The third layer 20 has at least one hollow void 24 provided therein. The hollow void 24 extend through the third layer 20. Each hollow void 24 is parallel to each other hollow void 24. The hollow voids 24 are also parallel to the first and fifth layers 12, 14.

Each layer is thermally bonded to the layer below by adhesives to provide additional strength to the composite board 10 and to make the resulting composite board 10 waterproof. In this manner, first layer 12 is thermally bonded by adhesive to second layer 16, which is in turn thermally bonded by adhesive to third layer 20 and so on.

The invention will now be described in the context of its intended method of manufacture.

The third layer 20 is manufactured by extrusion from a mould. Adhesives are then applied to two opposing sides of the third layer 20. The second layer 16 is then applied to the adhesive on one of these sides. The fourth layer 18 is applied to the adhesive on the opposite side. The plastic cover that forms the first and fifth layers 12, 14 is then extruded over the resulting construction.

A composite board 10 constructed in accordance with the description of the above invention has been found to be particularly suitable for use in decking structures, ceiling construction or any other wall partition or load bearing structure. Furthermore, a composite board as described is particularly suited for outdoor conditions.

In accordance with a second embodiment of the invention there is a composite board 100 of 10 mm thickness (T). The composite board 100 comprises five layers of various material compositions. The first layer 102 and the fifth layer 104 form a plastic cover made from a thermoplastic material having a thickness of 0.5 mm. The second layer 106 and fourth layer 108 are made of aluminium sheeting of 0.1 mm thickness. The third, middle, layer 110 is made from a combination of a thermoplastic material and a filler material. The third layer 110 has a thickness of 8.8 mm.

In this case, the thermoplastic material of the middle layer 110 makes up thirty percent (30%) of the total material of the middle layer 110. The remaining seventy percent (70%) is made up of wood filler as the filler material.

The first layer 102 and the fifth layer 104 each have at least one textured surface 112. The textured surface 112 is positioned such that it acts as an external face of the composite board 100.

The third layer 110 has at least one hollow void 114 provided therein. The hollow void 114 extend through the third layer 110. Each hollow void 114 is parallel to each other hollow void 114. The hollow voids 114 are also parallel to the first and fifth layers 102, 104.

In this embodiment, the third layer 110 is actually constructed from two separate components 116a, 116b. Each component 116 is identical in size and shape. At opposing ends 118 of the component 116 are connectors 120. The pair of connectors 120 are of such size and shape so as to allow the connector 120 from one component 116 to securely mate with the connector 120 of its adjacent component 116. In this manner, when the connectors 120 are so mated, the components 116 that form the third layer 110 present as one single elongate component 116.

Each layer is thermally bonded to the layer below by adhesives to provide additional strength to the composite board 100 and to make the resulting composite board 100 waterproof. In this manner, first layer 102 is thermally bonded by adhesive to second layer 106, which is in turn thermally bonded by adhesive to third layer 110 and so on.

The invention will now be described in the context of its intended method of manufacture.

The components 116 that form the third layer 110 is manufactured by extrusion from a mould. The components 116 are then connected together by mating respective connectors 120. In this embodiment, the third layer 110 comprises two mated components 116.

Adhesives are then applied to two opposing sides of the third layer 110. The second layer 106 is then applied to the adhesive on one of these sides. The fourth layer 108 is applied to the adhesive on the opposite side. The plastic cover that forms the first and fifth layers 102, 104 is then extruded over the resulting construction.

In accordance with a third embodiment of the invention, where like numerals reference like parts, there is a composite board 200 of 10 mm thickness (T). The composite board 10 comprises seven layers of various material compositions. The first layer 202 and the seventh layer 204 form a plastic cover made from a thermoplastic material having a thickness of 0.4 mm. The second layer 206 and sixth layer 208 are made of metal, in this case aluminium sheeting of 0.1 mm thickness. The third layer 210 and fifth layer 212 are made from a thermoplastic material having a thickness of 0.1 mm. The fourth, middle, layer 214 is made from a combination of a thermoplastic material and a filler material. In this case, the thermoplastic material is polyethylene and the filler material is wood filler. The fourth layer 214 has a thickness of 8.8 mm.

The first layer 202 and the seventh layer 204 each have at least one textured surface 216. The textured surface 216 is positioned such that it acts as an external face of the composite board 200.

The fourth layer 214 has at least one hollow void 218 provided therein. The hollow void 218 extend through the fourth layer 214. Each hollow void 218 is parallel to each other hollow void 218. The hollow voids 218 are also perpendicular to the first and seventh layers 202, 204.

Each layer is thermally bonded to the layer below by adhesives to provide additional strength to the composite board 200 and to make the resulting composite board 10 waterproof. In this manner, first layer 202 is thermally bonded by adhesive to second layer 206, which is in turn thermally bonded by adhesive to third layer 210 and so on.

The invention will now be described in the context of its intended method of manufacture.

The fourth layer 214 is manufactured by extrusion from a mould. Adhesives are then applied to two opposing sides of the fourth layer 214. The third layer 210 is then applied to the adhesive on one of these sides. The fifth layer 212 is applied to the adhesive on the opposite side. Adhesives are then applied to the exposed side of the third layer 210 and the fifth layer 212. The second layer 206 is then applied to the adhesive applied to the third layer 210. The sixth layer 208 is then applied to the adhesive applied to the fourth layer 214. The plastic cover that forms the first and seventh layers 202, 204 is then extruded over the resulting construction.

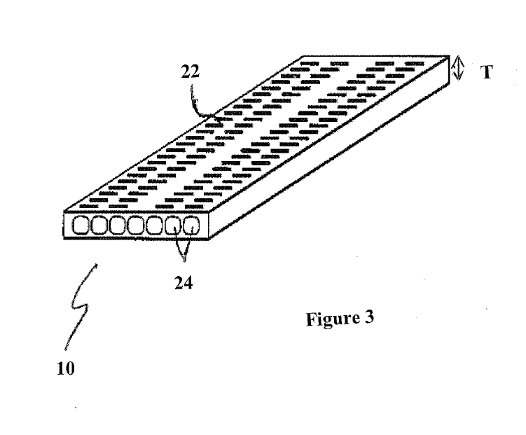

It should be appreciated by the person skilled in the art that the above invention is not limited to the embodiment described. In particular, the following modifications and improvements may be made without departing from the scope of the present invention:
The whole board may range from the 10 mm thickness mentioned above to 60 mm.
The first and fifth layers 12, 14 may have a flat, smooth surface rather than the textured surface 22 mentioned above. Alternatively, the textured surface 22 may be omitted and the raw face of the appropriate layer used in its place.
The second and fourth layers 16, 18 may be made of metal other than aluminium. In other variations of the invention, the second and fourth layers 16, 18 may be stainless steel or copper.
Examples of the type of thermoplastic material that may be used include: polyethylene; polypropylene; polyvinyl chlorate, polystyrene or acrylonitrile butadiene styrene.
In variations of the third embodiment of the invention, the thermoplastic material used for the first and seventh layers 202, 204 may differ from the thermoplastic material used in the third and fifth layers 210, 212.
Examples of the type of filler material that may be used include: talc fillers; wood fillers, fibreglass or any other reinforcing filling agent.
Spaced about one or more exposed surfaces of the board may be a series of ridges 22 as shown in FIG. 3. These ridges 22 are visible following installation of the composite board 10 so as to improve friction on the surface of the board. In this manner, the composite board 10 is also provided with additional anti-slip protection by way of the ridges 22 which makes it suitable for use in wet areas or similar areas where grip is an important consideration.
In the second embodiment of the invention described above, the ratio of wood filler to thermoplastic material may range from twenty percent (20%) to seventy percent (70%).
The second embodiment may be varied such that the first, second, fourth and fifth layer 102, 106, 108, 104 bond to a single component 116 rather than multiple components 116. In this manner composite boards 100 can be connected to each other by way of the connectors 120.
In variations of the second embodiment described above, the connectors 120 may be modified from their hook and recess design. For instance, the connectors 10 may take the form of a screw and threaded recess.
In yet a further variation of the second embodiment, the connectors 120 may be replaced with alignment aids. An example of such an arrangement involves a plurality of projecting dowels aligned to fit into recesses in an adjacent composite board 100. The projecting dowels may themselves be a separate component to the composite board 10 that fits into recesses provided in both composite boards 100 to be connected.
The first and fifth layers 12, 14 may vary in thickness ranging from 0.5 mm to 5.0 mm.
The second and fourth layers 16, 18 may vary in thickness from 0.1 mm to 1.0 mm.
The third layer 20 may vary in thickness from 5 mm to 50 mm.

It should be further appreciated that the above alternative features, where not mutually exclusive, can be combined to form yet further embodiments that fall within the scope of the present invention.

We claim:

1. A composite board comprising:
a first and fifth layer of thermoplastic material;
a second and fourth layer of metal; and
a third layer made from a combination of thermoplastic material and a reinforcing filling agent, the third layer including at least one hollow void,
where the second and fourth layers are fixed to the third layer through thermal bonding and the first layer and fifth layer are extruded over the second layer and fourth layer respectively.

2. A composite board according to claim 1, where the thermoplastic material is at least one of the following: polyethylene; polypropylene; polyvinyl chlorate; polystyrene; acrylonitrile butadiene styrene.

3. A composite board according to claim 1 or claim 2, where the metal is at least one of the following: aluminium; stainless steel; copper.

4. A composite board according to any preceding claim, where the reinforcing filling agent is at least one of the following: wood filler, talc filler; fibreglass.

5. A composite board according to any preceding claim, where the first and fifth layers have a thickness of 0.5 mm to 5.0 mm.

6. A composite board according to any preceding claim, where the second and fourth layers have a thickness of 0.1 mm to 1.0 mm.

7. A composite board according to any preceding claim, where the third layer has a thickness of 5 mm to 50 mm.

8. A composite board according to any preceding claim, where the composite board has a thickness of 10 mm to 60 mm.

9. A composite board according to any preceding claim, where the thermoplastic material makes up between 20% and 70% of the total material of the third layer.

10. A composite board according to any preceding claim, where at least one side of the first and fifth layers is textured.

11. A composite board according to any preceding claim, including ridges for preventing slippage.

12. A composite board according to any preceding claim, where the third layer includes connecting means to facilitate the connection of adjacent composite boards.

13. A composite board according to claim 12, where the connecting means takes the form of one or more of the following configurations: hook and recess; screw and threaded recess.

14. A composite board according to any preceding claim, including alignment aids for facilitating alignment of adjacent composite boards.

15. A composite board according to claim 14, where the alignment aids are dowels.

16. A composite board comprising:
a first and seventh layer of a first thermoplastic material;
a second and sixth layer of metal;
a third and fifth layer of a second thermoplastic material; and
a fourth layer made from a combination of thermoplastic material and a reinforcing filling agent, the fourth layer including at least one hollow void,
where the second and sixth layers are fixed to the third and fifth layers, respectively, through thermal bonding, which are in turn thermally bonded to the fourth layer, and the first layer and seventh layer are extruded over the second layer and sixth layer respectively.

17. A composite board according to claim 16, where the first thermoplastic material is identical to the second thermoplastic material.
